(19) United States
(12) Patent Application Publication
(10) Pub. No.: US 2016/0247049 A1
(43) Pub. Date: Aug. 25, 2016

(54) Monochrome Profile Generation Mechanism

(71) Applicants: Hong Li, Superior, CO (US); Juan Lin, Boulder, CO (US); Chao Ma, Boulder, CO (US); Yue Qiao, Longmont, CO (US)

(72) Inventors: Hong Li, Superior, CO (US); Juan Lin, Boulder, CO (US); Chao Ma, Boulder, CO (US); Yue Qiao, Longmont, CO (US)

(73) Assignee: Ricoh Company, Ltd., Tokyo (JP)

(21) Appl. No.: 14/628,787

(22) Filed: Feb. 23, 2015

(51) Int. Cl. G06K 15/02

(52) U.S. Cl. CPC G06K 15/188; G06K 15/1822; G06K 15/184

(57) ABSTRACT

A method disclosed. The method includes receiving color data, converting the color data to grayscale data by analyzing color gamut and perceptual color differences in the color data and generating a profile based on the conversion.

### FIELD OF THE INVENTION

The invention relates to the field of image processing, and in particular, to color printing systems.

### BACKGROUND

When color images are printed in grayscale at a print system, the images undergo a color to gray transformation. Various algorithms exist that are be implemented to convert color to grayscale. The most commonly used method obtains lightness/luminance and disregards chroma/hue information. The drawback of this approach is that colors with the same lightness/luminance, but different chroma/hue, are converted to the same gray value. This is most noticeable and objectionable for a job with a red, green and blue pie chart of similar lightness for instance.

Another known method incorporates color difference equations into the transformation from color to grayscale. This method involves more color attributes during the conversion than that of the lightness preserving method. However, this method often causes discontinuity or low contrast in some color regions.

Accordingly, a monochrome profile generation mechanism that preserves perceptual differences in lightness, chroma and hue with smooth transitions when converting color to grayscale is desired.

### SUMMARY

In one embodiment, a method includes receiving color data, converting the color data to grayscale data by analyzing color gamut and perceptual color differences in the color data and generating a profile based on the conversion

In another embodiment, a printer is disclosed. The printer includes a control unit to receive color data, convert the color data to grayscale data by analyzing color gamut and perceptual color differences in the color data and generate a profile based on the conversion.

### BRIEF DESCRIPTION OF THE DRAWINGS

A better understanding of the present invention can be obtained from the following detailed description in conjunction with the following drawings, in which:

FIG. 1 illustrates one embodiment of a data processing system network;

FIG. 2 illustrates one embodiment of a control unit;

FIG. 3 is a flow diagram illustrating one embodiment for performing color conversion;

FIG. 4 is a flow diagram illustrating one embodiment for generating a monochrome profile;

FIGS. 5A, 5B and 5C illustrate a pie chart implement to illustrate embodiments for generating a monochrome profile; and

FIG. 6 illustrates one embodiment of a computer system.

### DETAILED DESCRIPTION

A monochrome profile generation mechanism is described that enables colors with different lightness to be distinguishable, as well as the colors with the same lightness and different chroma/hue to be discernible. In the following description, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form to avoid obscuring the underlying principles of the present invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

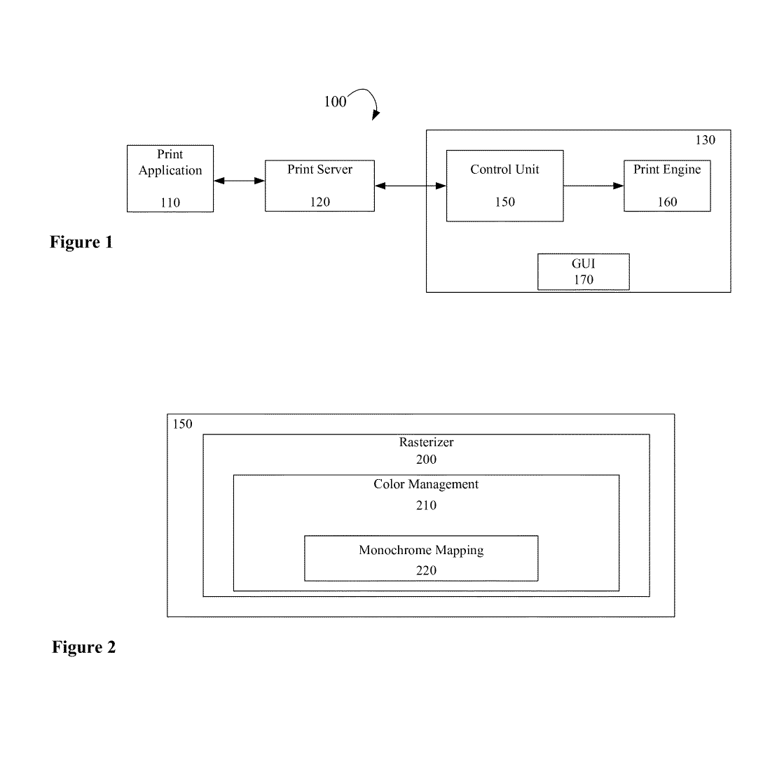

FIG. 1 illustrates one embodiment of a printing system 100. Printing system 100 includes a print application 110, a server 120 and printer 130. Printer 130 includes a control unit 150 and a print engine 160. Print application 110 makes a request for the printing of a document. In one embodiment, print application 110 provides data in the form of a page description language (PDL) (e.g., Advanced Function Presentation (AFP), PostScript (PS), Portable Document Format (PDF), etc.) file for printing to print server 120.

According to one embodiment, control unit 150 processes and renders objects received from print server 120 and provides raster maps for printing to print engine 160. FIG. 2 illustrates one embodiment of a control unit 150. Control unit 150 includes a rasterizer 200 having color management unit 210, as well as other units that will not be described herein.

Rasterizer 200 is implemented to process image objects received at control unit 150 by performing a raster image process (RIP) to convert an image described in a vector graphics format (e.g., shapes) into a raster image (e.g., pixels) for output to print engine 160. Color management unit 210 provides a color mapping from a source to a destination color space.

In such an embodiment, color management unit 210 uses ICC profiles to perform the mapping to determine CMYK values for each pixel in a particular object to be printed at print engine 160. Further, color management unit 210 may convert a print job file from an input color space to printer device space using an input ICC profile and printer ICC profile.

According to one embodiment, color management unit 210 includes monochrome mapping unit 220 provides color conversion mapping of a print job to black and white. Thus, monochrome mapping unit 220 implements a monochrome printer profile to enable the color conversion of a print job in any color space to black and white. In a further embodiment, monochrome mapping unit 220 performs the color conversion mapping based on an operator selecting a monochrome mode via a Graphical User Interface (GUI) 170 at printer 130.

In one embodiment, monochrome mapping unit 220 optimizes color to grayscale conversion by taking into account color gamut and perceptual color differences. In such an embodiment, monochrome mapping unit 220 maps colors to a desired color gamut, compresses chroma and lightness to the most visible and differentiable ranges, maximizes color differences in hue and the most sensitive areas in perception and optimizes the conversion with different weighting functions of a combination of lightness, chroma and hue.

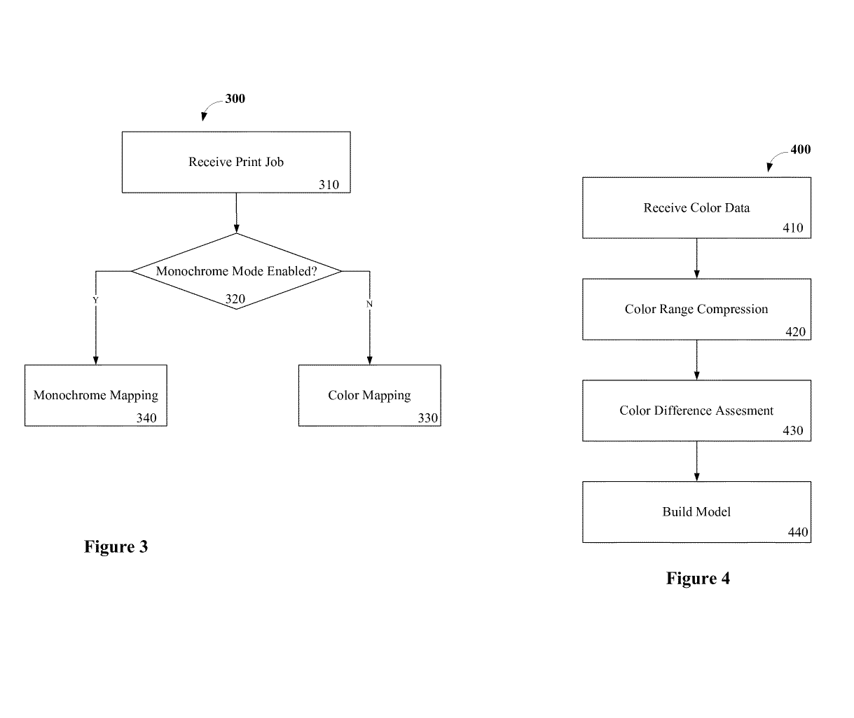

FIG. 3 is a flow diagram illustrating one embodiment for performing color conversion in a print file. Process 300 may be performed by processing logic that may comprise hardware (e.g., circuitry, dedicated logic, programmable logic, etc.), software (such as instructions run on a processing device), or a combination thereof. In one embodiment, method 300 may be performed by control unit 150. The processes of method 300 are illustrated in linear sequences for brevity and clarity in presentation; however, it is contemplated that any number of them can be performed in parallel, asynchronously, or in different orders. For brevity, clarity, and ease of understanding, many of the details discussed with reference to FIGS. 1 and 2 are not discussed or repeated here.

At processing block 310, a print job file is received at control unit 150. At block 320, it is determined whether monochrome mode is enabled. In one embodiment, the monochrome mode may be enabled or disabled by the operator at GUI 170. If the monochrome mode is not enabled, color management unit 210 performs color mapping to convert the color of each pixel of the received image to a corresponding output color based on the selected ICC printer profiles, processing block 330. However if the monochrome mode is enabled, monochrome mapping unit 220 performs the mapping, processing block 340.

FIG. 4 is a flow diagram illustrating one embodiment a process 400 for performing color to grayscale conversion in order to achieve monochrome mapping. Process 400 may be performed by processing logic that may comprise hardware (e.g., circuitry, dedicated logic, programmable logic, etc.), software (such as instructions run on a processing device), or a combination thereof. In one embodiment, method 400 may be performed by monochrome mapping unit 220. The processes of method 400 are illustrated in linear sequences for brevity and clarity in presentation; however, it is contemplated that any number of them can be performed in parallel, asynchronously, or in different orders. For brevity, clarity, and ease of understanding, many of the details discussed with reference to FIGS. 1-3 are not discussed or repeated here.

At processing block 410, color data is received. At processing block 420, color range compression is performed. In one embodiment, color range compression includes gamut compression, lightness compression and chroma compression in order to create sufficient spaces for more used colors. Lightness is a property of a color (or a dimension of a color space) that is defined in a way to reflect a subjective brightness perception of a color for humans along a lightness-darkness axis. Chroma is a perceived colorfulness in proportion to the brightness of a reference white patch.

In one embodiment, L, a*,b* grid points are mapped into a gamut of a standard RGB (sRGB) color space, and coordinates are changed to (L*, c*, h*). Subsequently, L is scaled by an scaling curve (S-curve), such that:

$$For L < {L}_{o} \text{:} L = \sqrt{L} - DH * sin ( x * \frac{p i }{DW} ) ; and \\ For L < {L}_{o} \text{:} L = \sqrt{L} + DH * sin ( ( x - {L}_{o} ) * \frac{p i}{DW} ) ) ;$$

After L scaling, C is scaled by an increasing curve such that:

$${C}_{1} = \frac{{C}_{input} - {C}_{mi n}}{{C}_{max} - {C}_{min}}$$

$${C}_{2} = 1.05 * ( 1 - exp ( - 2 * {C}_{1} ) )$$

$${C}_{output} = {C}_{min} + ( {C}_{max} - {C}_{mi n} ) * {C}_{2}$$

In one embodiment, the scaling of L and C may be performed manually. At processing block 430, color difference is assessed. In one embodiment the assessment includes lightness, chrome and hue. Hue is defined as a degree to which a stimulus can be described as similar to or different from stimuli that are described as red, green, blue, and yellow (e.g., the unique hues).

According to one embodiment, greater lightness (e.g., higher L value) colors correspond to less black in human eye. Monochrome level correspondence for different chroma may be complicated. Thus, given color patches with the same lightness, same hue angle, but with different chrome values, observers may have different opinions regarding which color appears to be blacker or whiter. Thus embodiments where larger—chroma values are chosen will result in “whiter” color.

Psychological experiments show that for high lightness and low lightness regions, monochrome level correspondence for different hue angles is different. Thus, embodiments feature two different hue weighting functions, which rely on human responses with different hue angle colors. In such an embodiment, one weighting function is implemented for L>L₀ and a second weighting function is implemented for L<L₀.

Hue weighting for high lightness (L≦30) corresponds to:

$${y}_{1} = 5.37 + 2.72 * cos ( ( x - 200 ) * 2 * \frac{p i}{360} ) ;$$

$$y = - wH / 2 + wH * \frac{{y}_{1} - 2.65}{5.44}$$

Similarly, hue weighting for high lightness (L>30) corresponds to:

$${y}_{1} = 5.37 + 2.72 * cos ( x * 2 * \frac{p i}{360} ) ;$$

$$y = - wH / 2 + wH * \frac{{y}_{1} - 2.65}{5.44}$$

At processing block 440, a model is built. According to one embodiment, an output function will determine the K values that will be written in a look up table in the monochrome profile. In such an embodiment, the output function is represented by:

$$Output = a * {L}^{2} + b * {( {wL}_{o} * ( wC * C - \frac{wC}{2} ) )}^{2} + c * {( {wL}_{o} * ( {wt}_{H} - \frac{wH}{2} ) )}^{2} + d * L + e * {wL}_{o} * wt\_H * C$$

As discussed above, the L and C values have been scaled in processing block 430. Wt_H is the hue weighting function defined with hue angle as input, while wLo is a weighing function with lightness as input. The remaining parameters (a, b, c, d, e, wC and wH) are to be determined by generating training data by using wt=L+wL₀*wt_H*C. Subsequently, the parameters are optimized using a nonlinear least square fit algorithm. This approach enables the use of any specified training data to obtain the optimized parameters that correspond to the data.

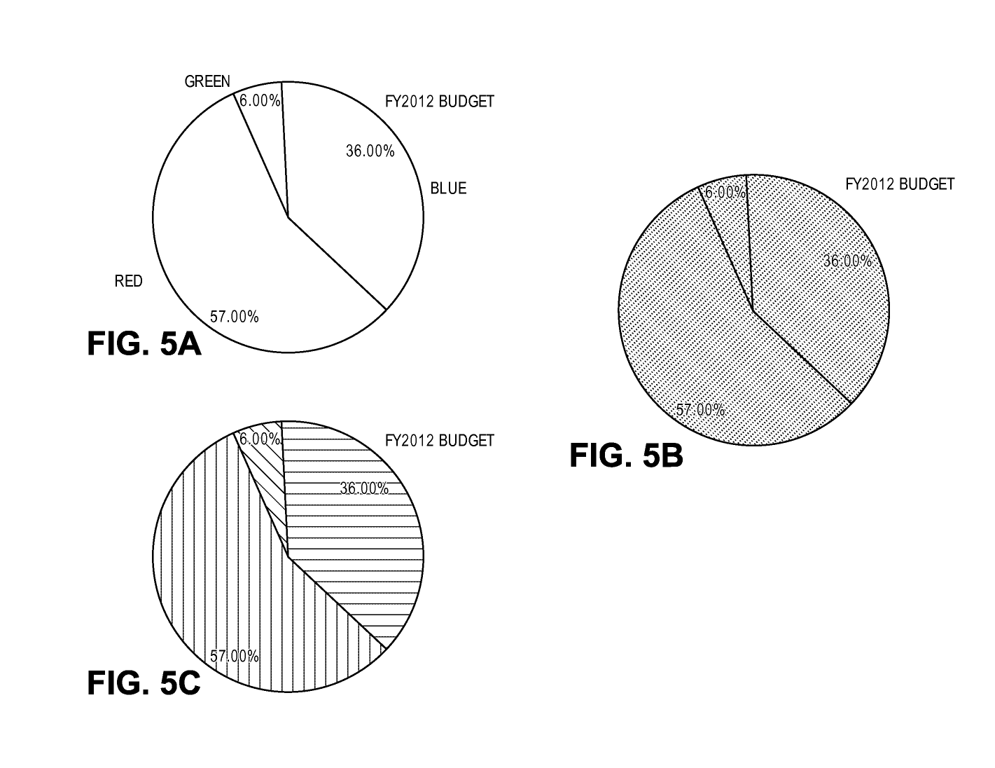

FIGS. 5A, 5B and 5C illustrate a pie chart implement to illustrate embodiments for generating a monochrome profile. FIG. 5A illustrates a color version of the pie chart showing red, green and blue components. FIG. 5B illustrates a grayscale version of the pie chart in which convention color to grayscale has been performed. As shown in FIG. 5B, the grayscale components corresponding to each pie chart color are indistinguishable. FIG. 5C illustrates a grayscale version of the pie chart performed by method 400. As shown in FIG. 5C, the grayscale components corresponding to each pie chart color is distinguishable, which permits analysis of a grayscale version of the pie chart.

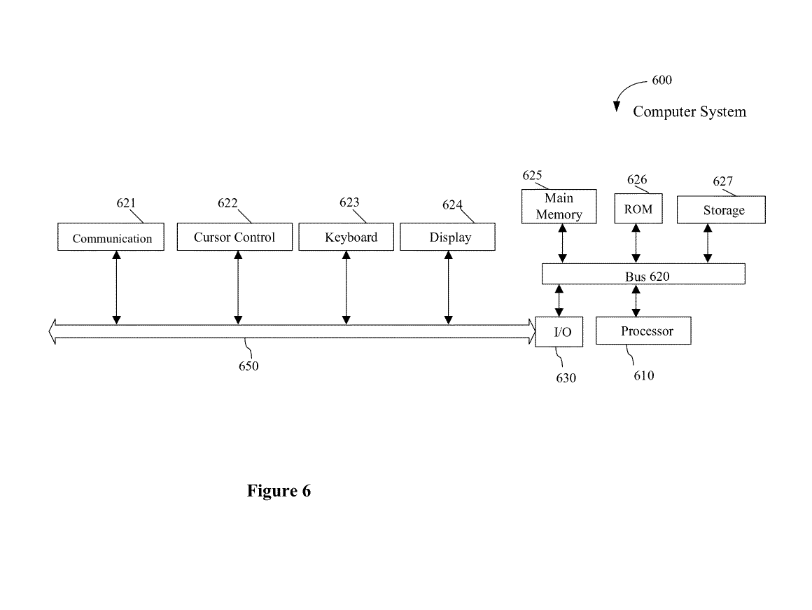

FIG. 6 illustrates a computer system 600 on which server 120 and/or printer 130 may be implemented. Computer system 600 includes a system bus 620 for communicating information, and a processor 610 coupled to bus 620 for processing information.

Computer system 600 further comprises a random access memory (RAM) or other dynamic storage device 625 (referred to herein as main memory), coupled to bus 620 for storing information and instructions to be executed by processor 610. Main memory 625 also may be used for storing temporary variables or other intermediate information during execution of instructions by processor 510. Computer system 600 also may include a read only memory (ROM) and or other static storage device 626 coupled to bus 620 for storing static information and instructions used by processor 610.

A data storage device 625 such as a magnetic disk or optical disc and its corresponding drive may also be coupled to computer system 600 for storing information and instructions. Computer system 600 can also be coupled to a second I/O bus 650 via an I/O interface 630. A plurality of I/O devices may be coupled to I/O bus 650, including a display device 624, an input device (e.g., an alphanumeric input device 623 and or a cursor control device 622). The communication device 621 is for accessing other computers (servers or clients). The communication device 621 may include a modem, a network interface card, or other well-known interface device, such as those used for coupling to Ethernet, token ring, or other types of networks.

Embodiments of the invention may include various steps as set forth above. The steps may be embodied in machine-executable instructions. The instructions can be used to cause a general-purpose or special-purpose processor to perform certain steps. Alternatively, these steps may be performed by specific hardware components that contain hardwired logic for performing the steps, or by any combination of programmed computer components and custom hardware components.

Elements of the present invention may also be provided as a machine-readable medium for storing the machine-executable instructions. The machine-readable medium may include, but is not limited to, floppy diskettes, optical disks, CD-ROMs, and magneto-optical disks, ROMs, RAMs, EPROMs, EEPROMs, magnetic or optical cards, propagation media or other type of media/machine-readable medium suitable for storing electronic instructions. For example, the present invention may be downloaded as a computer program which may be transferred from a remote computer (e.g., a server) to a requesting computer (e.g., a client) by way of data signals embodied in a carrier wave or other propagation medium via a communication link (e.g., a modem or network connection).

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims, which in themselves recite only those features regarded as essential to the invention.

1. A method comprising:
receiving color data;
converting the color data to grayscale data by analyzing color gamut and perceptual color differences in the color data, including:
performing color range compression;
assessing color difference in the color data; and
building a model to determine black values for the grayscale data that corresponds to color values in the color data; and
generating a monochrome profile to map the color data to the grayscale data based on the conversion.

2. (canceled)

3. The method of claim 1 wherein performing color range compression comprises:
performing gamut compression;
performing lightness compression; and
performing chroma compression.

4. The method of claim 3 further comprising:
mapping L, a*, b* color space grid points into a gamut of a standard RGB (sRGB) color space; and
changing coordinates to a L, c, h color space.

5. The method of claim 4 further comprising:
scaling the light component; and
scaling the chroma component.

6. The method of claim 4 wherein assessing color difference in the color data comprises:
performing a first weighting function for lightness values greater than a lightness threshold; and
performing a second weighting function for lightness values less than the lightness threshold.

7. The method of claim 6 wherein building the model comprises performing an output function to determine the black values for the grayscale data.

8. A printer comprising:
a control unit to receive color data, convert the color data to grayscale data by analyzing color gamut and perceptual color differences in the color data, including performing color range compression, assessing color difference in the color data and building a model to determine black values for the grayscale data that corresponds to color values in the color data, and to generate a monochrome profile to map the color data to the grayscale data based on the conversion.

9. The printer of claim 8 further comprising a monochromatic mapping unit to receive predefined color values, calculate color space coordinates corresponding to the predefined color values and perform monochromatic hue mapping to map the calculated color space coordinate values to grayscale values based on the profile.

10. (canceled)

11. The printer of claim 9 wherein performing color range compression comprises performing gamut compression, performing lightness compression and performing chroma compression.

12. The printer of claim 11 wherein the control unit maps L, a*, b* color space grid points into a gamut of a standard RGB (sRGB) color space and changes coordinates to a L*, c*, h* color space.

13. The printer of claim 12 wherein the control unit scales the light component and the chroma component.

14. The printer of claim 13 assessing color difference in the color data comprises performing a first weighting function for lightness values greater than a lightness threshold and performing a second weighting function for lightness values less than the lightness threshold.

15. The printer of claim 14 wherein building the model comprises performing an output function to determine the black values for the grayscale data.

16. An article of manufacture comprising a non-transitory machine-readable medium including data that, when accessed by a machine, cause the machine to perform operations comprising:
receiving color data;
converting the color data to grayscale data by analyzing color gamut and perceptual color differences in the color data, including:
performing color range compression;
assessing color difference in the color data; and
building a model to determine black values for the grayscale data that corresponds to color values in the color data; and
generating a monochrome profile to map the color data to the grayscale data based on the conversion.

17. (canceled)

18. The article of manufacture of claim 16 wherein performing color range compression comprises:
preforming gamut compression;
performing lightness compression; and
performing chroma compression.

19. The article of manufacture of claim 18 comprising a machine-readable medium including data that, when accessed by a machine, further cause the machine to perform operations comprising:
mapping L, a*, b* color space grid points into a gamut of a standard RGB (sRGB) color space; and
changing coordinates to a L, c, h color space.

20. The article of manufacture of claim 19 comprising a machine-readable medium including data that, when accessed by a machine, further cause the machine to perform operations comprising:
scaling the light component; and
scaling the chroma component.
